(19) United States
(12) Patent Application Publication
(10) Pub. No.: US 2019/0388787 A1
(43) Pub. Date: Dec. 26, 2019

(54) Method and System for Scenario Selection and Measurement of User Attributes and Decision Making in a Dynamic and Contextual Gamified Simulation

(71) Applicants: Sriram Padmanabhan, New York, NY (US); Aarti Shyamsunder, Navi Mumbai (IN)

(72) Inventors: Sriram Padmanabhan, New York, NY (US); Aarti Shyamsunder, Navi Mumbai (IN)

(21) Appl. No.: 16/436,837

(22) Filed: Jun. 10, 2019

Related U.S. Application Data
(60) Provisional application No. 62/683,366, filed on Jun. 11, 2018.

(51) Int. Cl. A63F 13/60; G09B 19/00; G09B 9/00; A63F 13/48; A63F 13/55

(52) U.S. Cl. CPC A63F 13/60; G09B 19/00; A63F 2300/1012; A63F 13/48; A63F 13/55; G09B 9/00

(57) ABSTRACT

The present invention allows organizations to set up, and its users to experience, dynamic, realistic gamified simulations in a cost- and time-efficient manner, as a means of iteratively assessing and developing individuals' work-focused decision making. It also enables measurement of user attributes and the process of decision making involved at work, through the process of experiencing such simulations. By closely mirroring, or realistically simulating the way data changes with users' decisions or with events external or internal to the organization, the invention is able to faithfully reconstruct the work environment of the user, generate true-to-life responses and unobtrusively measure behavior under various simulated situations. Overcoming existing challenges involved in measuring personal attributes (such as leadership competencies or decision making) in dynamic simulations, the invention allows assignment of scores to users regardless of the specific dynamic and idiosyncratic stimuli they are exposed to within the simulation experience, using the invention's method and system.

### CROSS REFERENCE TP RELATED APPLICATIONS

This Nonprovisional application for patent is related to A prior provisional application patent, Application Ser. No. 62/683,366, entitled “A Method and System for scenario Selection and Measurement of User Attributes and Decision Making in a Dynamic and Contextual Gamified Simulation” filed on 11 Jun. 2018, by the present inventors, Sriram Padmanabhan and Aarti Shyamsunder. The content of the prior provisional application is herein incorporated by reference.

### FIELD OF INVENTION

The present invention relates to the general field of education and training, more particularly to management development. It draws heavily from the subject of industrial-organizational psychology/work psychology, data science and from the area of online games and simulations.

### BACKGROUND OF INVENTION

Decision making, especially in context of organizational management roles is complex and unstructured. It takes place in an environment characterized by conflicting goals, constant context switching between competing priorities, processing of multiple concurrent risks and opportunities, many stakeholders to satisfy, and the assimilation of contradictory advice from a variety of sources. Such complex roles and responsibilities are also typically discharged without much active on-the-job hand-holding or coaching. Finally, errors made in such roles are likely to lead to bigger organizational damage than errors made in less complex positions.

Such decision making is qualitatively different from expertise in any narrow organizational function, which can be taught as skills, or acquired through experience and observation. The task of developing employees for roles demanding enterprise thinking and complexities, or of assessing employees for their potential fit for such roles, is therefore essentially different than narrower functional or skills training. To paraphrase Ericsson et al.: Given that expertise in any domain, including leadership, is difficult to assess and develop and that the challenges are complex and context specific, providing learners with contextual, realistic problems and repeated attempts to solve them would verily constitute the deliberate practice required to build expertise (Ericsson, Prietula, & Cokely, 2007, emphasis added). [Ericsson, K. A., Prietula, M. J., & Cokely, E. T. (2007). The Making of an Expert. Harvard Business Review. Retrieved from https://hbr.org/2007/07/the-making-of-an-expert.]

Academic interest has been focused on this problem since the 1950s, and there is broad consensus that gamified simulations are the optimal mechanism for assessing and developing fit for unstructured senior management roles, from a decision-making perspective (Sydell et al., 2013). [Sydell, E., Ferrell, J., Carpenter, J., Frost, C., & Brodbeck, C. C. (2013). Simulation scoring. In M. S. Fetzer & K. A. Tuzinski (Eds.), Simulations for personnel selection (pp. 83-107). New York: Springer.] However, in practice, there have been several difficulties that organizations have encountered in implementing such a strategy. These include the following:
The simulations need to be highly contextual, relevant to the job and realistic—in order for a) any assessments based on them to be accurate, and b) any learning to be easy to assimilate and apply, by participants;
If the solution is for one-time use only, it will not be able to capture fully the way people grow over time, by iteratively trying different options and developing their instincts for appropriate responses to situations. In order to be usable multiple times without the participants finding ways to cheat or ‘game’ the system, and also without the impact of memory and practice to impact future responses, it is necessary for the system to be interactive, dynamic and non-deterministic;
For the solution to be continuously relevant for a period of time, as the organizational context changes, it is necessary for it to be easy, quick and cheap to configure, modify and reuse;
For the solution to be scalable and non-disruptive for day-to-day business, it is necessary for it to be available anytime, anywhere, without the need for synchronous human observation, proctoring or intervention. This necessitates the use of an online or virtual solution.

Although most existing solutions define contextuality as the use of industry-specific jargon in the text given to the users, a true reproduction of an organizational context will comprise the following:
The use of the same, or very similar, historical data as that of the organization's—financial and non-financial data pertaining to the market, investors, employees, customers, and other areas relevant for decision-making;
The use of same, or very similar, goals, targets and objectives, as those against which the user has to make decisions;
Simultaneous occurrence of issues and situations of different levels of urgency and strategic importance, involving different stakeholders and aspects of the business;
The fact that certain outcomes of decisions can be immediately observed, while others are tougher to predict or observe, and take place over a longer duration;
The fact that certain outcomes depend on the circumstances at the time when the decision is taken and not only on the behavior of the actors;
The fact that the future does depend on the actions taken, but not always along completely predictable lines, and there is uncertainty attached to every eventuality.

This combination of requirements has made it difficult to design gamified or simulation-based assessments in practice. If the simulations are to be made highly complex and contextual, they take a long time and much cost to implement. And even then they are difficult to keep up to date. If they are off-the-shelf and affordable, they are unlikely to be contextually relevant enough for the organization and its specific context.

Added to these practical concerns, are the challenges inherent in psychometric measurement (measurement of person-related attributes) in an unstructured/dynamic simulation (Handler, 2013). [Handler, C. (2013). Foreword. In M. S. Fetzer & K. A. Tuzinski (Eds.), Simulations for personnel selection (pp. v-ix). New York: Springer]

Current solutions in the field of employee/worker assessment and development cover a gamut—from psychometric tools such as personality tests, situational judgment tests or cognitive ability tests; to ‘work sample’ tools such as assessment centers, simulations and of late, gamified assessments such as virtual assessment centers, virtual role plays or job tryouts that constitute realistic job previews. Traditional psychometric methods use sparse, self-contained pieces of evidence such as responses to multiple-choice items. With advances in digital/virtual environments, every click, keystroke, or interaction in an online assessment or simulation can be mined to inform outcomes like learning, thus challenging psychometricians to extend insights into relatively underleveraged and under-explored realms of measurement.

The usual method of building an interactive simulation or situation/context-based assessment instrument is the decision-tree, where scenarios for a stage are decided based on the participant's responses at the previous stage. Every time an option is chosen, the next node connected to it will always get triggered. This makes the decision-tree approach to building an interactive simulation static and deterministic. A participant can, by simply following the different branches of the tree, arrive at a quick understanding of the rules of the simulation, and then be able to predict the simulation outcomes accurately and take decisions in such a way as to achieve the target results.

But, such an exercise would prepare the participant insufficiently for real life situations and tell us nothing about the competencies and behaviors she is likely to exhibit in real life situations, where cause-effect relationships are less straightforward to predict. Thus, a decision-tree approach does not allow for repeated use.

The decision-tree method also rapidly becomes unwieldy when planning a simulation across more than 3-4 stages. For a four-stage simulation, for example, assuming four options for response per scenario, the decision-tree approach would require the set-up of 340 decision nodes (4+16+64+256). This adds hugely to the cost and effort of building an online simulation. Sometimes, to circumvent this, a trained human observer is placed at hand to review the participants' responses and dynamically pick the test scenarios. But this again makes the solution costly and non-scalable; trained observers are in short supply and scheduling conflicts make the process disruptive and unrealistic.

The current invention minimizes the need for a human observer or coach by creating a novel virtual, digital ‘sandbox’ that allows users to experiment with different decisions and approaches in a realistic, yet simulated context. To recreate a realistic experience, it leverages, inter alia, the elements of existing solutions, such as, serious games (including feedback, realism, points), simulations (including real-world data and situations), and situational judgment tests (including realistic organizational scenarios and decision making) etc. But our disclosure goes beyond these features and practices.

The important aspects for optimal assessment and subsequent personal development, especially for leaders, include the extent to which an individual can: Make and execute plans, prioritize information from numerous sources, make day-to-day strategic as well as operational decisions, work well with others, learn and grow from feedback, deal with multiple stakeholders and competing priorities, retain organizational values and objectives, and so on. Such aspects are difficult to assess utilizing simple multiple-choice or Likert type (continuous scale) response formats, common in traditional psychometric assessment approaches. The difficulty also lies in measuring these aspects by the currently available scoring and analytics approaches which don't always factor in elements such as the dynamism, idiosyncrasy, simultaneity of inputs, combination of detailed and holistic priorities and so on.

Resolving the tradeoff between (structured) measurement and dynamism within simulations, and then making reasonable inferences about people based on their wide open and unstructured interactions within complex simulated work environments of all types, therefore, is the Holy Grail for measurement in simulations. The present invention takes combines the strengths of work psychology, with its high-quality measurement techniques and rich theory about organizational behavior with those of data science, that has flexibility and analytical power.

It is in this overall background that the present invention has been designed.

### SUMMARY OF INVENTION

At its core, the present invention discloses a software system and a method for dynamically delivering an online simulation experience as well as a system and a measurement framework for scoring, analyzing and summarizing critical human attributes that may be inferred from users' behavior and choices within such an experience. This disclosure sometimes refers to ‘market,” “profit,” “enterprise” etc. However, it is applicable more generally to organizations which can be analyzed by the principles of management described herein.

First, the delivery system and method of this invention involves picking a number of scenarios to present to a user at every juncture in the online, gamified simulation (that is, during each “move”, which may be a unit of time like a month or a quarter, in the “game”, which we are using interchangeably with gamified simulation for the sake of convenience), such that the picked scenarios are the most probable ones to take place given the state of the hypothetical organizational context and given all that has taken place until that point. Briefly, the method—
Utilizes a basic machine learning technique, the Hidden State Markovian Model
Makes it easy to design or “author” a simulated work context, and easy to modify a simulation that can run for any number of ‘moves’, without having to create complex decision-trees
Allows for a high degree of realism and high face validity/psychological fidelity
Is probabilistic, dynamic and non-deterministic, and so makes it nearly impossible for a user to experience the exact same configuration of scenarios or events more than once

The resultant system is a faithful reproduction of real work life, in that
Decisions do result in changes in organizational data, but not all changes are predictable and observable. The extent of the changes varies depending on the circumstances under which the decisions were made
Unlike simulation-based analysis of financial models that test for capital adequacy in unfavorable economic scenarios, the present system is more comprehensive, including both financial and non-financial aspects of the enterprise. Additionally, the present system incorporates human elements of decision-making—such as adherence to organizational values, ability to identify risks and opportunities, exercising judgment, displaying preferences and choices—and not just the systemic elements. Finally, the test scenarios are not pre-programmed in a static way, but take place according to their probability, given the situation at any point.
An important characteristic of this system is that there is no static script according to which the simulation unfolds. Events are not necessarily directly triggered by actions or other events. The probability of an event taking place increases or decreases according to the circumstances. In the Hidden State Markovian model, the circumstances are defined by the state of health of the organization along any number of dimensions at any time (described in the detailed description section below) However, these definitions are not available to the participant, and the rules for transitioning from one state of health to another are also hidden from them.

This leads to an unscripted, dynamic experience that best reflects the incompletely predictable nature of real life challenges.

Second, in addition to presenting a dynamic experience, the invention also includes a system and a measurement framework for scoring, analyzing and summarizing critical human attributes that may be inferred from users' behavior and choices in digital/virtual, dynamic, gamified simulations. This framework includes:
conceptualizing and scoring behavioral competencies as complex products of person-situation interactions, i.e. “Reimagining Competencies as Person-Situation Interactions Using a Partial Credit Model”
harnessing ‘paradata’ (i.e. clickstream, choice patterns, time taken etc.) to provide scores on decision-making processes, i.e. “Human Information Processing: Insights Using Paradata”
using within-simulation interpersonal behavior to create collaboration or advice-seeking indices, i.e. “Communication Indices: Insights Using Paradata”
analyzing user-generated constructed response text-based, audio or video data, i.e. “Analytics using Natural Language Understanding, Natural Language Processing, Text Analytics etc. for Constructed Response Data”
providing trajectories of change within and across individuals to assess growth over time, i.e. “Measuring Individual and Group Developmental Trajectories”

### BRIEF DESCRIPTION OF THE DRAWINGS

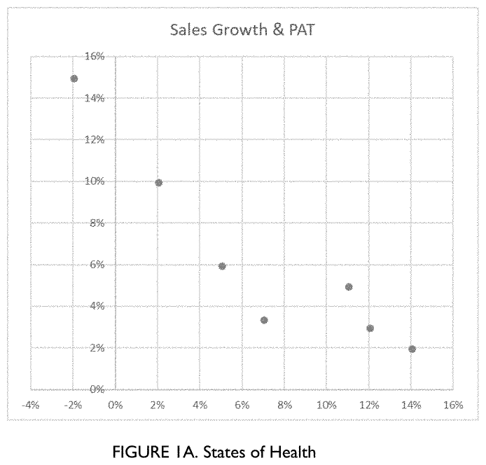

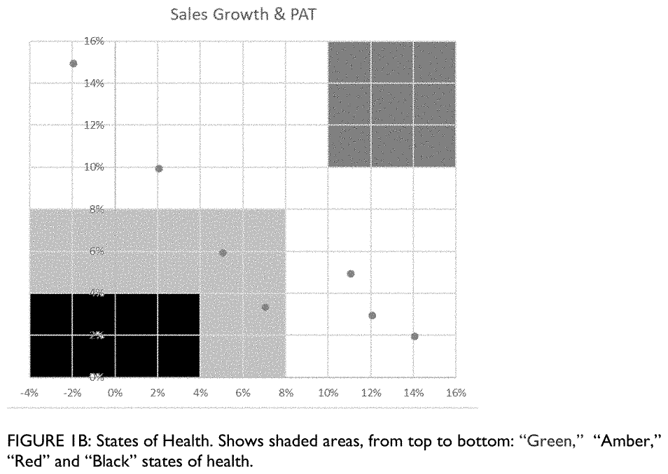

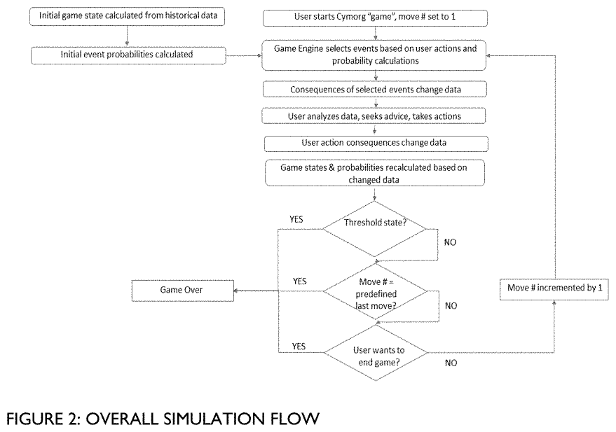

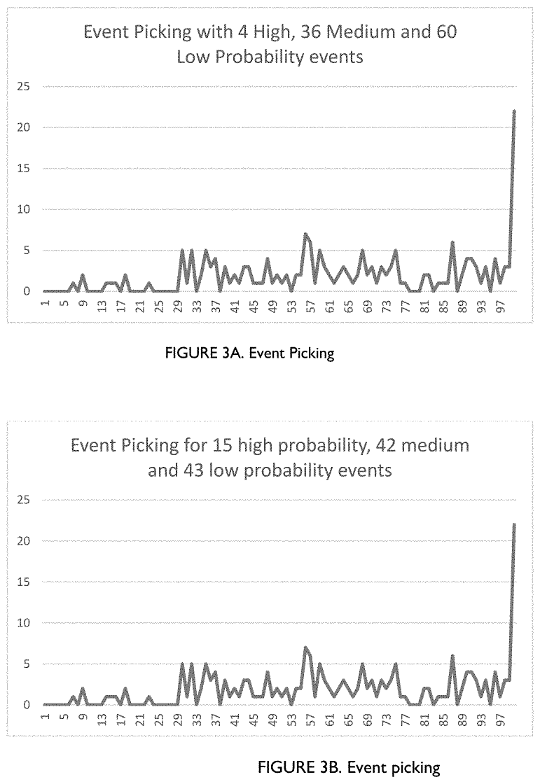

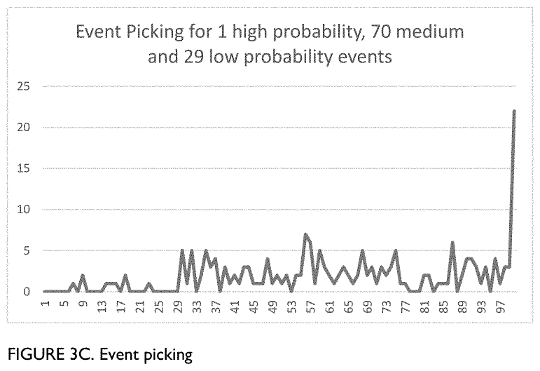

a) FIGS. 1a and 1b depict the States of health and how states are defined).
b) FIG. 2 depicts the overall flow of the game, i.e., Overall simulation flow.
c) FIGS. 3a, 3b, 3c depict simulation results using the method of the present invention, and in particular the “Event picking logic.”

### DETAILED DESCRIPTION

“So it seems that at present, the use of simulations forces us to choose between raw empiricism that does not provide sound trait-based measurement and highly structured and less fluid simulations, that while measuring important traits, place limitations on realism and complexity. I believe that the future lies in bridging this gap.”
   Handler (2013, p. viii)

The current invention, tentatively named Cymorg, is an online system, available in on-the-cloud and on-premise models, as well as the method of creating this system. It is designed for use in the context of organizational decision-making.

Provided below in this section are the details of: The product (including its architecture, and access); its use, including the experience delivery method (calculating base trends, states of health, events, actions and consequences); the method of event picking—a key, novel component of the invention—with illustrative event picking examples; and, the method or framework for measurement, including behavioral competencies, conceptualized as complex person-and-situation interactions, the harnessing of ‘paradata’ for information processing and communication indices, analyzing constructed responses, as well as trajectories of change.

Description of Cymorg—the Product

Architecture

The system consists of the following architectural components:
REST APIs (Representational State Transfer Application Programming Interfaces), through which the processing is available to the user interface layer
Cache: a layer that extensively caches (temporarily stores/accumulates) all master data, configuration, game states, etc., to enhance speed of access and processing
Databases: a transactional database, a secondary database for disaster recovery and a reporting and analytics data store
Game Engine: various components that work together to implement the core processing logic
Data synchronization service: This keeps the Cache and Databases in sync

Access and Use

When an organization implements the Cymorg system as their platform for assessing and developing user attributes and decision making, a separate instance of the system is created for that organization, hosted either on the cloud or in the organization's own premises. One or more designated “admin” users are created in the system at the time. These admin users can thereupon:
Model their organization in the system by defining its structure (e.g. functions/departments, geographies, markets etc.);
Define the configuration settings: time limits for the users (i.e. the individuals ‘playing’ or experiencing Cymorg), individual versus group-based experience, number of stages in the simulation, number of events encountered per stage, etc.;
Decide which data elements (“parameters” such as profits, sales, employee satisfaction—as examples) are important for their purpose to be tracked and at what levels within the modeled structure the parameters are to be stored;
Incorporate real, historical or fake (i.e. mock) data for these parameters from organizational repositories and other sources;
Based on the specific objectives of the users being assessed and developed, their seniority and functions, and the context of the firm, decide on a set of work-relevant scenarios (events and action options) that are suited for purpose;
Choose from an available library of scenarios in the system, modify it, or create new scenarios from scratch;
Finalize the overall design in consultation with the organization, verifying that the modeling, scenarios, consequences, targets set etc. resonate with them;
Create user IDs and passwords;

Once the design is finalized, the users (participants or “players”) can access the system using their user IDs. They see a brief tutorial which describes system features, initial information about the status of the organization, their own role and the targets they need to achieve, the need to create plans for achieving their targets, and budget for those plans.

The simulation begins with the setting of a “virtual calendar” to the first stage (week, month or quarter, as pre-configured) of the simulation duration.

A set of events is made available to the user, and the organization data set to be changed based on the impact of those events. For each event the user can analyze the available data, seek advice, read up about the issue on external sites, then choose to ignore the event, respond to it or take a completely unrelated, proactive action. When the user exhausts the number of actions she can take in a single move, or chooses not to avail of her full quota of actions, the simulation moves to the next stage (week, month or quarter, as configured), and the system generates a new set of events based on the impact of the actions of the previous stage(s) as applicable. Changes are reflected in the newly visible data, and these new values are made visible on the user dashboard.

If at any time, the organization slips below pre-designated threshold values for certain combinations of data elements, the game ends unsuccessfully (e.g. the financial health of a certain organization may be measured as the combination of its Profit After Tax figure and its monthly Growth in Revenues, and if both these drop below defined numbers, the game ends). Otherwise, it ends when the last stage of the simulation is successfully completed, or when time runs out (in case the configuration stipulates a time limit).

Analytical reports can be generated after the game.

Comparing Cymorg Product with Similar Existing Products

Cymorg is novel compared to games or activities that allow “playing” with management issues and decision making in several important ways.

Cymorg is a dynamic platform, not static, where all organizational data is subject to change at every move.

Furthermore, Cymorg is customizable to the changing situations of a particular organization. As described above, the organizational data of interest is input at the outset by the user, who also steers the decision-making moves with as much information made available as possible by the computerized play.

Cymorg incorporates the distinctions between acceptable and unacceptable outcomes by measuring the likely impact of simulated decisions through the flexible parameter, “state of health” of the organization, which is defined and described in the States of Health section below.

Description of the Method: The Cymorg “Experience”

In order to create realistic experience for the user, the methodology of Cymorg relies on several, customizable variables and parameters. These include the historical “trends,” quantified “states” of organizational health and a framework of risks and rewards, which are described next, along with a flexible method of quantification and computation.

Base Trends

The Cymorg method involves modeling the organization structure and ingesting as much historical/context-specific data as is deemed necessary for realism and relevance. This could be data pertaining to the organization's finances and cash flow, market data pertaining to customers, competitors, partners, vendors, regulators and other market entities, or, internal data pertaining to the employees of the organization. These data projected into the future using extrapolatory statistical techniques (simple regression, for example), and the ‘base trends’ for each of the parameters tracked are calculated. It is assumed that the organization would continue to exhibit these trends, in the absence of any new external or internal events. Currently there are no limits on the number of parameters Cymorg can accommodate—however, practically one usually ends up with 50-80 parameters to model.

In the current embodiment of Cymorg we assume that the historical data is generated by data feeds, but the source of these data feeds could be any available source with probable downstream impact on the “game,” including any or all of the following:
Organizational data either sourced from public domain filings of the organization, or explicitly provided by the organization from their internal accounting and other systems
Industry, and market data that is considered relevant for decision-making by the organization, sourced from publicly available information like stock market price movements, currency exchange rates, unemployment, housing prices, inflation and other economic indicators
Customer behavior and Competitor related financial and product information sourced from organization's own repositories or from internet research

The system can also work with fictitious organizations modeled for the purpose of use in the system, with imaginary, realistic looking but “dummy” historical data fed into it before the system is available to be experienced. Additionally, while there are no minimum number of datapoints required to create this ‘history’, and one could merely specify just the current state—that might mean there wouldn't be trends generated for this historical data, which would be a static value until the user starts impacting the value within the Cymorg game experience itself.

In the future embodiments, certain elements and/or types of the data, e.g., trends for social sentiment and job market and market perceptions about the organization and its products and leadership, may be generated directly by means of data scraping, machine learning enabled analytics etc. based on the organization's mentions in relevant public media and social media sites.

States of Health

The next step in configuring the system is to define a set of “states” that determine the “health” of the organization along several different dimensions: employee satisfaction, customer loyalty, investor confidence, regulatory landscape, social goodwill, etc. The state of health along any dimension is measured by means of the current values of certain variable parameters, by themselves or in combination. As an example (see FIG. 1. A), the financial health of a certain organization may be measured as the combination of its Profit After Tax figure and its monthly Growth in Revenues.

In FIG. 1. A., the Y-axis depicts Sales Growth and the X-axis depicts that Profit After Tax of the organization at the end of a month. At any juncture in the game, the “virtual organization” has distinct values for both these parameters, and so the financial health of the organization correspondingly is represented by a point on the Sales Growth & PAT scatter plot. This point moves across the 2-dimensional graph as the simulation proceeds and PAT and sales data change month by month.

It is possible to identify regions in the graphical space as representing different “states of health” of the organization. FIG. 1. B. shows the graph of FIG. 1A segmented into the following four regions, where identifying color in the name is for convenience only:
a) A “Green” state of health, defined by PAT>10% and Sales growth >10%
b) A “Black” state of health, defined by PAT<=4% and Sales growth <=4%
c) A “Red” state of health, defined by 4%<PAT<=8% and 4%<Sales growth <=8%,
d) An “Amber” state of health, defined as not green, not red and not black

Most of the points in this particular example lie in the Amber region, except for two in the red zone.

This simple example illustrates a 2-parameter definition of Financial health, with the scatter graph divided into four zones or regions. It is, possible to define the Financial health or any other ‘state’ of an organization using a combination of the values of any number (n) of different parameters. Once you can visualize an n-dimensional scatter graph, you can divide the space into mutually exclusive regions or zones, such that they collectively fill the entire space without overlapping. Then, the simulation at any single juncture, will have values defined for each of the n parameters, and so can be represented by a single point on the n-dimensional scatter graph. The zone in which that point lies defines the state of health of the game on that parameter. Similarly, one can define the Market state of Health, the Investor State of Health, the Customer state of health, or other such categories. At any juncture, for any category along which we are measuring health, the simulation is in one (and only one) zone.

Thus, at any time in the simulation, an organization's state of health can be measured along several categories, but for each category, there is one, and only one, unambiguously defined zone in which the organization lies. Therefore, the likelihood of a particular scenario taking place can be attached to the value of the state of health of the organization along any one of the categories: certain events are more likely to take place under certain circumstances than under others. For instance, a steep drop in share price is an event that is less likely to happen when the state of financial health is in the Green state than when the point is somewhere deep in the red zone.

For every category, it is possible to designate the zone with the combination of the worst outcomes (e.g., the “Black” state of Financial health in the example above) as a Threshold State. When the simulation point falls within the threshold zone, the simulation comes to an end, and the participant's effort is deemed “unsuccessful”.

Events, Actions and Consequences

When events (scenarios) are authored into the game, their probability of occurrence is attached to these states of health. When an event takes place, it can change the value of some financial and other parameters. The participant, in response, may take an action, which will have intended and unintended consequences for the value of the parameters. Because of the changes in data values, the state of health of the game, along each of the dimensions, may undergo a change. When that happens, the probability of the various possible events may change, as well. The engine then picks the most probable events in the new state of the game.

FIG. 2 shows the overall flow of the simulation's progress by the process steps and sequentially marked arrows.
1. As part of the authoring/configuration stage, historical/contextual data of the organization is used to generate base trends for every parameter being tracked; these trends are used in projecting the data into the “future” in which the simulation will be run next. The values of the data elements being tracked are calculated as part of the projection process. The various states of health of the organization along each of the pre-defined categories at that juncture are calculated.
2. Based on the states of health, the relative probability of all available events is calculated, some of which would be highly probable to occur, others less probable.
3. The system is pre-configured to run for a certain number of “moves” or virtual time periods. When a user begins using the system, the move number is set to 1.
4. Based on the number of available high, medium and low probability events, and the average number of events required to be picked, the actual probability of the events is modified while keeping their relative likelihood the same; then, events are “picked” from the list by choosing random numbers and comparing them against the probability of each event;
5. When an event is “picked”, it can change the value of some of the parameters being tracked, both immediately and over a longer term; The values of all the data elements and the states of health are re-calculated;
6. Based on organizational goals, targets, market context, etc., and the knowledge of the events that have taken place, the “player” takes an “action”, by which she tries to deliberately change the value of one or more parameters;
7. The system is designed to have both intended and unintended consequences of the user action taken; Depending on the states of health of the organization at that juncture, the actions may affect the parameter values in different ways; The parameter values are recalculated after the impact of the actions is taken into account.
8. The states and probabilities of all available events are recalculated after the changes caused by the action consequences
9. If the organization has transitioned into a threshold state, the simulation comes to an end, and the user is deemed unsuccessful at completing the game
10. If the user wishes to continue, the simulation moves into the next “move”, and the cycle is then repeated from step 4 above, until the move number reaches the pre-assigned maximum value.

The process stops when the game is ended by the user/player/participant, or when a pre-defined number of “moves” or event-action loops is completed successfully, or when a pre-defined threshold state is breached in any category, indicating an unsuccessful completion.

As to adjustment of probabilities during recalculation, we note that some events cannot happen more than once in a game, so if they have occurred, their probability goes to zero. Other relationships also hold true—a few events are mutually exclusive (if one of them occurs, the rest cannot and their probabilities reset to zero) and a few are triggered directly by one another (their probability goes to one after a designated lag), overriding the ‘state of health’ derived presentation of events in this case.

Event Picking

The Markovian model ensures that the entire information about all past choices and events is encoded into the current state, thus taking away the need for elaborate decision trees of sequences. That said, the method still needs to figure out an efficient mechanism for “picking” the most probable events from the event set, reducing it to a manageable and predictable number, and “making them happen”.

For the game to be interesting, a very large number of events has to be available, but only a very small number should be visibly in the play per move. This small number can vary a little but not too much, around a pre-set average value. From empirical considerations, we try to ensure that the number of events that we put in front of a participant at any one time, is a number that is less than 6 or 7. The number 7 is recommended based on the long-established idea that this is the average capacity of short-term memory—we process about 7 units of information (plus or minus 2) (e.g. Miller, 1956). [Miller, G. (1956). The magical number seven, plus or minus two: Some limits on our capacity for processing information. The psychological review, 63, 81-97.] We may then be able to make interesting insights from observing how participants prioritize between these events. (This number ‘7’ is recommended, but not fixed and is completely configurable based on requirements).

It is impossible to know before the game begins what the number of available events will be before a particular move, and what their individual probabilities of occurrence are going to be. The method performs calculations before every move to ensure that a manageable number of events is chosen in that move.

Let Eⱼ=the expected number of events that take place in the j^{th} move. Let Pᵢⱼ be the probability of the i^{th} event taking place in the j^{th} move and let there be Nⱼ events available to be picked. Then we calculate

Eⱼ=ᵢ₌₁Σ^{N}Pᵢⱼ

(by analogy, if we are rolling 10 unbiased dice and wish to calculate the expected number of sixes, we will find that it is 10*(1/6)=1.67)

We need to figure out event probabilities such that we can expect a manageable number of events to take place.

At all times, the core principle is that vastly more probable events should occur far more times than very unlikely events. To ensure this, we took a “quantized” view of probabilities to begin with. Instead of allowing probabilities to be evenly spaced all over the (0,1) space, we allow for only a certain number of discrete levels for the probability of an event: for instance, “highly probable”, “moderately probable” and “highly improbable”. In this example, Pᵢⱼ's can only take 3 values: a very high value (designated Pₕᵢ), a very low value (designated Pₗₒ) and a moderate value in between these (designated P_{med}) While we have used 3 levels in this example, our approach can be generalized for any given number of discrete probability levels.

To differentiate strongly between highly probable events, moderately probable events and highly improbable events, we further stipulate that

Pₕᵢ>>P_{med}>>Pₗₒ

In other words, the high probability events are much more probable than the moderately probable ones, which in turn, are much more probable than the improbable ones. To confirm this, we define a factor F such that

Pₕᵢ=F*P_{med}.

P_{med}=F*Pₗₒ

For instance, for F=9, we have Pₕᵢ=9*P_{med}=81*Pₗₒ

In this example, if a “low probability” event has a probability of 0.01, the “medium probability” events would have probability of 0.09 and the high probability events would have the probability of 0.81.

F is the Relative Likelihood factor, and indicates the degree of surprise in the game. The bigger the difference between likelihood of high probability events and that of low probability events, the greater the proportion of high probability events that get selected. Thus the higher the chosen F factor, the more we will get highly probable events chosen every turn. When F is 10 or higher, for instance, the low probability events are less than a 100 times as likely to get picked as a high probability event. Where a small number of events is to be selected from a large available set of high, medium and low probability events, very few, if any, low probability events will get picked.

On the other hand, the lower F is, the more the number of ‘black swan’ low probability events sneaking into the game. In the limit, when F=1, we get a perfectly random chaos with every event being a surprise.

When F<1, we enter an outer darkness where madness lies, and where the events that take place are the exact opposite of what we expect. At F=0, nothing happens. No event takes place.

Event Selection Logic

Somewhere between that terrible fate and the boring simplicity of absolute predictability, lies a complex world where a user may find events one expects to see most of the time, but may still be occasionally surprised by something unexpected. This situation closely resembles real life.

Now the problem reduces to this: how can we control the expected number of events, with the ‘high probability’ events showing a significantly higher frequency of occurrence than the lower probability events?

Two other alternatives considered and rejected as unsatisfactory for logic of selecting events were:
1) Shortlisting events to ‘take place’ based on random number generation and the probability of each event, but picking at random only a preset number of events from the shortlist
2) Making the simplifying assumption that the probability defined is not that of an event happening, but that of an event happening GIVEN that a certain number of events must occur (in other words, reducing it to a ‘draw-x-balls-from-a-bag-of-balls-without-replacement’ problem)

Both options are artificial and unrealistic in mandating a specific fixed number of events to take place every move, regardless of the probabilities of the events available. The procedure below has been invented to ensure that a realistic experience is maintained while staying true to the relative likelihood of the available events.

For the j^{th} move, let there be a total of Nⱼ events available for selection.

Some of these events will be high probability events, some medium probability and the rest low probability.

Let Nⱼ=N_{j,hi}+N_{j,med}+N_{j,low}

N_{j,hi}=number of high probability events available In move j, N_{j,med}=number of medium probability events available In move j, and N_{j,lo} are low probability events that are available in move j.

Since in our model, all the high probability events have the same discrete probability value Pₕᵢ, all the medium probability events have the same probability P_{med} and all the low probability events have the same probability value Pₗₒ, the expected value for the number of events taking place in move j is:

Eⱼ=(N_{j,hi}*Pₕᵢ)+(N_{j,med}*P_{med})+(N_{j,lo}*Pₗₒ)

As discussed above, the aim is to have a small number of events, varying around a small expected value to be picked by this process.

Thus the problem reduces to finding the probabilities Pₕᵢ, P_{med} and Pₗₒ such that the expected value of events that will take place is the number we want, while continuing to maintain the Relative Likelihood factor F.

To make Eⱼ=a preset number k, we multiply all probabilities by the fraction k/Eⱼ, to arrive at a new adjusted probability for each event. This will maintain the relative ratio between the event probabilities but will also allow for a realistic variability in the number of events per move.

In order to make Eⱼ=a pre-set number k, we set

Pₗₒ=k/(F²*N_{j,hi}+F*N_{j,med}+N_{j,lo})

P_{med}=F*Pₗₒ

Pₕᵢ=F²*Pₗₒ

By knowing k, the pre-set average number of events to be picked, the number of high, medium and low probability events available (Nₕᵢ, N_{med} and Nₗₒ), and the multiplication factor F that distinguishes the probabilities of events, we can then solve for what the individual probabilities need to be.

Once we have re-calculated the probabilities of individual events in this way, their relative likelihoods continue to be the same as before, while the overall expected value of events to be picked reduces to the number we want. We now “pick” events according to a simple method:

```
For each event Eᵢ in the list of N available events
      Choose a random number R in the (0,I) space
      If R <= P(Eᵢ) consider Ei “picked”.
      Else, Ei has not been picked
Next event
```

Event Picking Examples

This section demonstrates how the method works with different distributions of events with high, low and medium probabilities. In each example, events are picked 60 times (i.e. the algorithm is run and picks up events 60 times) in the method described, with an average of 3 events to be picked at any one time. The desired result is that more probable events get consistently picked more often than less probable ones, but that some moderately probable events and the odd low probability event also do get picked up once in a while.

### Example

Let us, as an example, take a sample of 100 events: 4 high probability events, 36 medium probability events and 60 low probability events. Let us assume an F factor of 9 (in other words, high probability events are 9 times more probable than medium-probability events, which in turn are 9 times more probable than low probability events)

Then, Pₗₒ=3/708=0.0042

P_{med}=0.0381

Pₕᵢ=0.3432

Now, when we run the simulation, we get:

Maximum events per move=8

Average events per move=3.03

Case 1, Depicted in FIG. 3. A.

This figure shows which events were picked up.

The 4 high probability events are 97-100, and the first 60 events are the low probability ones.

Over 60 moves (or 60 runs of the event-picking algorithm), a total of 181 events were picked up. Of these, 46% were high probability events, only 6% were low probability events (despite only 4% of all available events being high probability, and 60% of all available events being low probability).

Case 2, Depicted in FIG. 3. B.

For the same example: A different distribution: where N (hi)=15, N (med)=42, N (low)=43

Because there are 15 high probability events, and only 3 are getting picked at any time, chances are that almost always only high prob events will get picked.

Here Pₗₒ=3/1636=0.0018

P_{med}=0.0165

Pₕᵢ=0.1485

These are the results of the simulation:

Maximum events per move=6

Average events per move=2.82

When we ran the Cymorg event picking engine, the results were as depicted in FIG. 3b.

The 15 probable ones feature prominently. Each high probability event occurs at least 6 times), and in total, high probability events account for nearly 80% of all events picked. The moderate ones do get a look in now and then (none more than twice), and once in a blue moon, we see a few very unlikely events take place as well. There's something in it for everyone.

Case 3, Depicted in FIG. 3.C.

For our last example, depicted in FIG. 3.C., we will choose a distribution with 1 high-probability event, 70 medium-prob events and 29 low-prob events.

The one high probability event took place 22 times (way more often than any other event, but only 11% of all events that got picked up). Because 70% of all events were mid-probability events, most of the events that took place were mid probability events (accounting for 83% of all events), while the low probability events, though 29% of the total available events, only occurred 6% of the time.

Delivering the Cymorg Experience: Summary

The method under discussion involves assigning event probabilities in 3 (or 4, or 5, or any small number of) discrete levels only, where each probability level is a multiplicative factor more likely to occur than the next rarer level, and to adjust the expected value for the number of events likely to take place to a pre-set average number, by applying an adjustment factor on the probabilities. This allows for:
Easier set up of new games, by making the probability choices easy to choose
Delivery of a slightly varying number of events in every move, within a manageable number
High probability events at all times to have a much better chance of occurring than medium or low probability events

These allow the invention to simulate reality to a much better extent than existing solutions do.

Description of the Measurement Framework for Dynamic Gamified Simulations

Cymorg, that forms the foundation for this invention, is a digital platform for dynamic, gamified simulations that may be used to assess and develop people using contextual realism, dynamism, and a focus on simultaneity of pursuits and a holistic experience. While such an experience is unique and valuable exactly because of its contextual realism and rich mimicking of real work experiences, there are challenges in scoring or measurement of human attributes and decision-making processes given this complexity. For instance:
Given the numerous possibilities in terms of the user's responses, each of which has probabilistically determined impacts on downstream events and consequences, no two experiences (even of the same user) are likely to be identical or even similar. Thus, comparisons across and within people are difficult and careful calibration is required to ensure that inputs are scored appropriately.
Also, in the absence of a clear ‘question-answer’ format, what elements of the experience should even be scored?
Thanks to technology, it is possible to track and record hundreds of datapoints each minute—these game play logs or ‘click streams’ record every action taken (such as asking for help, reading instructions, taking action within a certain time etc.) which affects the running state of various indicators of success or failure. Processing such data require data science and analytical approaches not usually employed by traditional psychometric assessments or solutions.

The challenge that the current invention tackles, therefore, is to develop a framework or a structure of making reasoned inferences from a dynamic, gamified simulation, in the absence of structured measurement maps between user behavior (choices, responses, decisions made, clicks used, time taken, actions prioritized etc.) and meaningful scores on outcomes of interest (behavioral competencies, predictions of success or failure in similar situations, choice preferences, development trajectories etc.). In order to fully leverage the measurement potential of such simulations and their “point to point correspondence” or the extent to which they reflect or correspond to real life, one needs to attend to what is called “simulation complexity,” in which the external experience and the internal design (how the simulation progresses and is scored) are aligned in terms of their complexity. The invention of the measurement framework therefore, is intimately tied to the simulation experience to maximize simulation complexity.

At the outset, Cymorg will be able to provide descriptive analytics, based on sound theoretical and rational frameworks. Over time, as more data is collected and decision science and analytics are leveraged to further advantage, the reports will incorporate predictive and prescriptive insights, realizing the full promise of sound substantive frameworks combined with technology and analytics to provide complex forecasting models.

The following paragraphs describe the main aspects of this measurement method: a new operationalization for human behavioral competencies measurement, a method of using paradata to evaluate human information processing as well as communication patterns in organizations, using text analytics methods to assign scores for constructed responses, and identifying trajectories of change over time and across people.

Reimagining Competencies as Person-Situation Interactions Using a Partial Credit Model

Research in psychology has established that human behavior is a complex interplay between nature and nurture in general, and in any given instance, between the person's dispositional attributes (such as personality, motives, values, attitudes) and situational factors (such as pressures to conform, to evoke biases or stereotypes, to act in self-interest or obey authority, etc.) (e.g. Buss, 1977). [Buss, A. R. (1977). The trait-situation controversy and the concept of interaction. Personality and Social Psychology Bulletin, 5, 191-195.] Assessments used in organizational settings, such as for hiring, for providing developmental feedback or performance management, often use competency models or frameworks (sometimes referred to as performance dimensions frameworks, leadership frameworks or behavioral competency models) as the foundation for these (Campion et al., 2011). [Campion, M. A., Fink, A. A., Ruggerberg, Carr, L., Phillips, G. M., Odman, R. B. (2011). Doing competencies well: Best practices in competency modeling, Personnel Psychology, 64, 225-262.] A common understanding of competencies is as combinations of knowledge, skills and abilities, which have behavioral manifestations. These are therefore often conceptualized, written and assessed, using behavioral anchors or defined/operationalized as behaviors. E.g. a commonly occurring competency is ‘effective communication’—and this may be operationalized in a performance ratings form as the behavior of “communicating in a clear, direct and impactful manner”.

Since such behaviors are actually the result of both person-specific and situation-specific influences, it is advantageous to also measure them as such. The current invention, therefore, reimagines competencies to break down the behavioral elements (that which is observable), into its component parts in two major steps at the time of design:

(1) using competencies as the building block from which to create scenarios or situations within the simulation and

(2) assigning weights (i.e. offering ‘partial credit’—or some proportionate weight or score) that represent the ‘saturation’ of these competencies in various situations as well as individual actions.

In this manner, using theoretical knowledge and rational judgment by subject matter experts such as organizational leaders or HR/leadership experts, the design of the simulation itself includes behavioral competencies as a combination of person and situation influences. In other words, this invention captures a measure of a complex person-by-situation interaction, which considers the ‘appropriateness’ of each response or individual behaviour with respect to the event that called for it, instead of considering the behaviour or the event in isolation. Ultimately, for an individual experiencing the simulation, scoring algorithms that use this conceptualization produce end reports that summarize the individual's position on various competencies. This is described further below.
During the design/setup/authoring phase of the simulation, each scenario or event is assigned a weight or proportion—the partial credit—(e.g. from 0 to 1) according to the saturation of various competencies in it. For instance, an event like “The VP of Sales in the North announces that she is leaving you for a competitor” has various elements to it . . . so it may be assigned various weights against different competencies (e.g. 0.8 for “Managing Others”, 0.6 for “Business Acumen” and 0.6 for “Customer Focus”).
Various possible actions or responses may be generated or may exist in the simulation's library. Several of these may apply in any given case. These actions would vary in terms of their appropriateness for each event—and this match itself is saturated with how much of a competency is in play in that choice. E.g. for the event above, an action like “Meet personally with the VP of Sales immediately in an effort to retain her” is high on the competency “Managing Others”—(perhaps 0.8), and somewhat high on the competency “Influence” (perhaps 0.6) but does not even tap into the competency “Innovation”, or has only an oblique bearing on it, and thus is not assigned a weight for it. Another action like “Request the CHRO to speak with the VP of Sales” may be lower on the competency “Managing Others”—perhaps only a 0.4
Thus, every event/scenario and event-action pair will be mapped to a set of competencies, using weights that signify the amount or saturation of those competencies in these events and event-action pairs.
During the gamified simulation, if the user sees an event and takes an action in response to it, this will trigger a score for all the competencies that have been mapped in the above-described manner.
This score is the multiplicative product of the weight of the event, and of the event-action pair, divided by the maximum assigned weight for that event (this division is done to control for the fact that for some events, perhaps there are more appropriate responses than for other events). For instance, in the running example, if someone selected the second action—“Request the CHRO . . . ”, their score would be (0.4*0.8)/0.8 i.e. 0.4 but for someone who selected the first action—“Meet personally . . . ”, their score would be (0.8*0.8)/0.8 i.e. 0.8
Across all the user's actions in the simulation, therefore, a running tally of competency scores will be created. Their ultimate score on each competency will be that total divided by the number of events that tapped into that competency (i.e. an average). This score can be converted into standardized scores such as stens, percentages, even percentiles if normative groups are available for cohort comparisons or norms.
Further, because Cymorg's games are dynamic and not pre-scripted, it may happen that over the course of a complete simulation, some players do not receive events that sufficiently test their scores on one or more of the competencies. Thus some of the competency scores may be the effect of a large number of data points, while others may the effect of just one or two. To prevent this from happening, it is possible to configure a simulation in the following manner:
   RULE 1: Define a weightage (between 1 and 10), as the minimum weight beyond which an event can be called an adequate measure of a particular competency
   RULE 2: Define a minimum number of total actions within a game that indicate a particular competency, and a minimum number of actions pertaining to an event that is an adequate measure of a competency.
   At the end of a game, if there are any competencies that have not adequately tested in that game according to RULE 2 above, the game reports will not publish scores for that competency
   In order to maximize competency coverage in every single game (i.e., to minimize the number of competencies for whom insufficient testing has taken place), we have added logic in the core engine, that overlays the event picking logic described in sections above. The engine picks a set of events for every move, checks to ensure that at least one of the picked events is an adequate measure of a competency that has not yet been “covered” adequately. If on the other hand, it finds that all the picked events of the move have already been measured adequately in this game, it would discard all the picked events, and try again. While this method is not infallible, it is likely to minimize the risk of complete games not having adequate coverage of all competencies.

Human Information Processing: Insights Using Paradata

The aspect of human information processing of the invention assigns scores to prioritization of choices made within the gamified simulation, using a logical point scheme that leverages the internal engine and design of the simulation. The point scheme is deliberately generalized in order to be flexible and accommodate changes to variables it uses, while also retaining uniqueness and specialization in its logic/rationale for scoring.

Within the gamified simulation, a number of events can occur simultaneously within a ‘move’ (a unit of time within the simulation, such as a month, or a quarter), just like in real life. These events can be a mix and can be tagged by the most representative ‘category’ (domain, area, aspect of interest) a priori. As an illustration, each event in a simulation about a global multinational software services organization may be tagged as belonging primarily to a category such as ‘customer’, ‘investor’, ‘finance’, ‘employee’ or ‘market’.

We stipulate the following, as a precondition to explaining the generalized scheme for assigning points to users' actions within the simulation:
If ‘m’ number of events occur during a move, they may all belong to the same category, or all belong to different categories, or some combination thereof
Prioritization is always relative in nature. By selecting one action/option, the user is automatically de-selecting other options.
When a user responds to an event tagged to a certain category, that response or action results in the respective category gaining (or losing) the assigned number of points.
At the end of the simulation, the cumulative number of points per category provides an indication of relative prioritization.

Generalized Point Scheme:
There will always be a fixed number of actions, ‘n’, possible per move
There will be a variable number, ‘m’, of events per move.
The average number of events per move will be equal to ‘n’ also
The minimum number of events per move will be 1 (one) and the maximum will be N (where N>n)
The number of points awarded during an event that is picked for response, depends on the number of other options the individual had at the time of the choice (i.e., if s/he had no other choice, it isn't really a prioritization).

Scoring Rules
1. Scoring Rule 1: The category of the first event to get picked out of the list of m events that take place in the move gets (m−1) points, the second gets (m−2) and so on. The category of the last event to get picked gets 0.
   In addition, the act of picking is a relative one, so when an event is picked, all the other available yet-unpicked choices at the time get −1.
2. Scoring Rule 2: The sum of points distributed every move is zero, except in the following cases:
a) An event is ignored (either explicitly ignored by selecting an ‘ignore’ option or stating it somehow, or just not selected during that move), despite the availability of actions/options that remain unused. In this case, the category of the ignored event gets −1. This is an act of active and deliberate deprioritization.
b) An event is ignored (either explicitly ignored or just not selected during that move), and instead, an event from a previous move is picked. In this case, the ignored event category gets −0.5 and the previous move event gets +0.5. (here, the sum total of points distributed in that specific move is negative, but the sum total across the entire game is still zero).
c) An event is ignored (either explicitly ignored or just not selected during that move), and instead, a proactive action is taken. A proactive action is one that is not provided as an option within the simulation but is something the user does proactively. In this case, the ignored event category gets −0.5 and the category associated with the proactive action gets 0.5. Currently, one may choose a proactive action among several available in a library. If one chooses to construct a response (e.g. type in or speak) proactively, then natural language processing will be used to categorize that response into a pre-existing category, and then a score will be assigned to that category.
d) When a previous move event is responded to, or proactive action taken while there are yet-unpicked events in the current move, all the available unpicked events' categories at the time this happens get a −0.5. If some of them get picked later in the same move, they will get points as per Rule 1 above.
3. To calculate the cumulative prioritization score for each category:
a) At the end, for each category, the points across all events and moves are summed up, including partial scores for “previous move” and “proactive” actions
b) The ‘maximum’ score that the player could have achieved in each category is calculated—if all its events had been completely prioritized over all other categories at every move, per the scoring rules above
c) The ‘minimum’ score that the player could have achieved in each category is calculated—if all its events had been completely deprioritized over all other categories at every move, per the scoring rules above
d) The cumulative score's distance to the maximum score is the final prioritization score, calculated as a proportion or percentage

Communication Indices: Insights Using Paradata

Within the gamified simulation, it is possible to communicate with both virtual and real persons, in synchronous and asynchronous ways. These communications may be traced to reveal patterns in terms of three key areas: collaboration, advice-seeking behaviors, and influence on others.

A sampling of the kinds of ‘paradata’ (clickstream, data about data) that may be used for these communication indices and the kinds of indices that may be calculated include the following:
1. Collaboration
   a. Degree to which help was sought and given
      i. With respect to ‘real’ others (e.g. in multiplayer mode) and also to ‘virtual’ others (e.g. from machine-generated virtual advisors)
      ii. With respect to contacting coaches (e.g. asynchronously or offline)
      iii. Collaboration under stress (e.g. under ‘red alert’ conditions)
   b. Degree to which individual is perceived to be an expert by a group
      i. Number of times recommendation is sought
      ii. Number of times recommendation is taken
2. Advice Seeking
a. Advice seeking formulas to determine the influence of experts, role power etc.
b. Consensus seeking
   i. Extent to which consensus was reviewed, used as is, or considered in further action
   c. Reliance on advice versus exploring own options
   d. Usage of advice under stress (e.g. when the simulation is in a ‘red alert’ state)
   e. Relationship between advice seeking and categories, competencies or other ‘tags’ of the events in question
3. Influence
   a. Extent to which the user's recommendations were heeded by others
   b. Social/organizational network analyses to reveal about the person's influence in terms of centrality, reciprocity, clustering, social networking potential etc.

Analytics for Constructed Response Data

Within the delivery method described earlier, in addition to selecting responses from a library of possibilities, users may also construct responses by typing in text, or in the future, speaking in their responses which would be thus be recorded in audio, video or text formats. These constructed responses would be matched with the most appropriate option in the library, which, in turn, would be used to decide the change in data values in the next iteration of the simulation. If an exact match isn't found at first, the system would engage the user in conversation (using Chatbot technologies), and ask a series of questions to determine the best option among those available.

Also, there are other points of interaction which allow for or even require (based on admin configuration) constructed responses. For instance, users may be asked for their rationale for choosing specific actions, or users' interactions with coaches, other users (especially in group mode) or notes to themselves can all be recorded. Such data, which take the form of text—even if in audio or video form—provides rich potential for analytics. Text analytics using Natural Language Processing (NLP), Natural Language Understanding (NLU) or other derived analytics methods will be used to identify themes, sentiments, code responses into pre-identified or newly created categories or otherwise make sense of these data.

Measuring Individual and Group Developmental Trajectories

All the indices presented in the previous paragraphs were described at the individual level of analysis—such as the user's competency profile, the user's prioritization/choices, and the user's communication patterns. Each of these may be conceivably aggregated to the group level, and also tracked across time, to yield different levels of insights about change over time and across people. For instance, perhaps a trajectory of growth across people might show a sudden change in some people on some competencies, which may be the result of an intervention or learning event. Alternatively, lack of growth or consistency in scores of a user over time in some areas, such as a tendency to prioritize certain type of events to attend to, might reveal a dispositional attribute.

Table 1 provides a few of these examples.

TABLE 1
Mixed-methods measurement at the individual and group level

| What is being measured? | | How is it being measured? | |
|---|---|---|---|
| Individual Level | Group Level | Individual Level | Group Level |
| Person | Group Cultural | Patterns of responses | Aggregations of user |
| | Norms or Habits | across events | response patterns |
| Situation | Group Goals or | Within-person | Prioritization of |
| | Areas of Focus | prioritization of | contextual |
| | | contextual | elements/events across |
| | | elements/events | users |
| Person-Situation | Shared Mental | Partial credit model to | Prevailing clusters or |
| interaction | Models, Group-level | score event-response | ‘kinds’ of behaviors |
| | Competency Models | combinations mapped to | across users |
| | or Shared | competencies | |
| | Performance | | |
| | Expectations | | |

We give below in Table 2, the Glossary of terms as a “dictionary” as used here or commonly understood in the literature.

TABLE 2
Glossary of terms

| | |
|---|---|
| Assessment | A test or a method of systematically gathering, |
| | analyzing, and interpreting data and evidence to |
| | understand the level of performance or of some |
| | underlying trait or human attributes such as learning, |
| | knowledge, personality, behavioral tendencies etc. |
| Assessment centers/Development | A process by which candidates are assessed for their |
| centers | suitability to specific roles (typically leadership roles in |
| | organizations), using multiple activities or exercises, |
| | multiple assessors and multiple dimensions on which |
| | candidates are assessed. |
| Action | At every move, the user has the option of taking a |
| | limited set of ‘actions’, either in response to the events |
| | that have occurred, or proactively, in the pursuit of the |
| | user's goals and targets. Actions usually have |
| | consequences in the form of changes to organizational |
| | data, both intended and unintended. |
| Authoring | The process in Cymorg by which an organization is |
| | modeled into the software, historical data is ingested and |
| | regressed into the future, and possible scenarios are |
| | downloaded or created along with their probabilities of |
| | occurrence, mapping with the competencies being |
| | assessed/developed, and consequences to the data. |
| Cognitive abilities | Evidence of general intelligence, general mental ability |
| | or a ‘g’ factor, which underlies performance on a variety |
| | of related tasks and abilities to do with mental |
| | functioning including problem solving, reasoning, |
| | abstract thinking, logic, concept formation, memory, |
| | pattern recognition etc. |
| Competency | A combination of knowledge, skills and abilities, |
| | manifested in behaviors of employees at work (used |
| | typically in Human Resources, Learning and |
| | Development contexts). |
| Constructed Response | A response (in the context of assessments, typically) |
| | which the respondent or user creates using their own |
| | inputs, instead of selecting from a preexisting set of |
| | stimuli. Examples include writing in answers to open- |
| | ended questions, speaking a response, etc. |
| Context (also, contextual, context- | The organizational set up and environment with its |
| specific) | constraints, data and goals, where the Cymorg |
| | experience occurs. |
| Data science | An interdisciplinary field that uses scientific methods, |
| | processes, algorithms and systems to extract knowledge |
| | and insights from structured and unstructured data, |
| | combining programming, machine learning, statistical |
| | analyses and content expertise. |
| Decision tree | A decision support tool that uses a tree-like graph or |
| | model of decisions and their possible |
| | consequences/outcomes; a way to display an algorithm |
| | with strictly bounded conditions, perhaps using a |
| | flowchart diagram with ‘nodes’ and ‘branches’ like trees. |
| Deliberate practice | Purposeful and systematic practice with the goal of |
| | improving performance over time. |
| Deterministic | A system or model where a predictable output is |
| | achieved each time, based on strict and static rules, |
| | where randomness or probability do not play a role in |
| | determining outcomes. |
| Development (including employee | The process of developing or changing people |
| development, leadership development, | (employees, leaders, managers) with a specific |
| management development) | organizational goal in mind, using systematic or planned |
| | efforts such as training programs. |
| Empirical/Empiricism | Based on verifiable observation, data or experience, |
| | rather than by theory, rationality or logic. |
| Enterprise thinking | Thinking at the organizational or system level, |
| | considering multiple stakeholders, priorities and |
| | objectives simultaneously. |
| Event | An occurrence - internal or external to the firm - that is |
| | presented to the user as part of the Cymorg experience. |
| | An event may have strategic, tactical or no importance |
| | to the goals and objectives of the firm. A set of events is |
| | presented to the user at every move. |
| Expected number of events | Given a set of independent events that can occur, each |
| | with a probability of occurrence, the ‘expected number |
| | of events’ is a statistical construct that is defined by the |
| | long-run average value of the number of events that |
| | occur, given a large number of repetitions of the |
| | experiment. |
| Expertise | Expert skill, knowledge, competency in a domain or |
| | field. |
| Face Validity | The extent to which the process appears to effectively |
| | meet its stated goals or measure what it's designed to |
| | measure; the appearance of validity. |
| Feedback | Information about performance or behavior sent back to |
| | the individual user, with the intention of helping them |
| | improve or change their performance or behavior in the |
| | future. |
| Functional training/skills training | Training tailored to a specific organizational function; |
| | training focused on the skills or task-relevant knowledge |
| | required for fulfilling a specific function at work. |
| Games | An activity or system in which people (one or more |
| | players) engage in an artificial setup, characterised by |
| | competition or conflict, rules, scoring systems and well- |
| | defined endpoints or goals. |
| Gamification/gamified | The application of typical elements of game playing |
| | (e.g. point scoring, competition with others, rules of |
| | play) to organizational aspects such as leadership |
| | development, marketing endeavors or rewards and |
| | recognition, in order to enhance employee engagement. |
| Gamified simulation | Simulations (as defined in list below) that have been |
| | enhanced with gamification techniques like targets, |
| | achievements and group score comparisons, with a view |
| | to increasing user engagement and immersion. |
| Hidden State Markovian Model | A statistical model involving a sequence of possible |
| | events with the probability of each event depending only |
| | on the state attained after the previous event, even |
| | though the state itself is not directly observable by a |
| | user. |
| Industrial-organizational | Industrial-organizational (I-O) psychology is the |
| psychology/work psychology | scientific study of working and the application of that |
| | science to workplace issues facing individuals, teams, |
| | and organizations; applying the scientific method to |
| | investigate work-related problems. |
| Item | A specific unit of responding on an assessment or test - |
| | e.g. a problem, a question or a statement to which an |
| | individual provides a discrete response |
| Likert | The most commonly used rating scale in survey |
| | research, named after its inventor Rensis Likert, in |
| | which respondents indicate their attitudes or opinions on |
| | a continuous multi-point scale (typically 5 or 7 points of |
| | agreement/frequency). |
| Machine learning | A field of computer science where statistical techniques |
| | are used to give computers the ability to perform tasks |
| | without being explicitly programmed. |
| Measurement | The assignment of a number or value to a characteristic |
| | of an individual, an object or other construct, to allow |
| | for comparison and easy understanding of the |
| | operational meaning of these constructs. |
| Move | A period of virtual time - typically either a quarter or a |
| | month - within which a set of scenarios are presented to |
| | the user and their responses are collected. Once the |
| | responses are in, the simulation proceeds to the next |
| | move, or virtual time period, or the simulation ends. |
| Multiple choice format | An item or question type in testing/assessment, which |
| | consists of a problem (the stem) and a list of suggested |
| | solutions, known as alternatives, one of which is the |
| | correct or best alternative and the remaining are |
| | incorrect or inferior alternatives, known as distractors. |
| Node | Within a decision tree model, a node represents a |
| | decision point - the decision node represents the choice |
| | at that point, resulting in ‘branches’ which are the |
| | outcomes/consequences of that decision, and the leaf |
| | nodes are the labels of those decisions. |
| Norm | A result of ‘norming’ - a process by which a group |
| | aggregate is derived, and individual scores are able to be |
| | compared to each other, using their relationship to the |
| | group ‘norm’ or relative performance. |
| Off-the-shelf | Ready-made (not designed or created to order; not |
| | custom-made or bespoke, but generic) solutions that are |
| | meant for generic/universal application without any |
| | customized features or functionality. |
| Paradata | Data collected about the usage of the system, which can |
| | be analyzed for meaningful insights into the user's |
| | preferences, priorities and styles of decision-making |
| Partial Credit | A scoring system or model, where each response |
| | receives some proportion of the maximum possible score |
| | and need not receive a binary pass/fail or yes/no result. |
| Percentile | A number that indicates the percentage of observations |
| | that fall below that value, in that specific sample or |
| | group of observations. |
| Person X Situation framework | Framework used in the present method which analyzes |
| | competencies in terms of the interplay between the |
| | characteristics of a person (traits, preferences etc.) and |
| | those of a situation (market and organizational context, |
| | goals, values, strategic levers, etc.). In psychological |
| | theory, the Person X Situation framework describes the |
| | interaction between person-specific, dispositional |
| | influences and situational, environmental influences on |
| | behavior. |
| Personality | The constellation or organization of dispositional traits |
| | that define a person and represent their particular and |
| | characteristic adaptation to their environment. |
| Preset average number of events | In the present system, the number of events presented to |
| | the user for response is allowed to vary at different |
| | stages of the simulation around an average value that is |
| | set as part of the configuration effort. The number of |
| | actions that the user is allowed to make is typically a |
| | fixed number that is equal to this average number of |
| | events. This allows for analytics around situations where |
| | the user has to prioritize among a larger set of events |
| | than allowable actions, and where the user has more |
| | actions available than events to respond to. |
| Psychological Fidelity | The extent to which the psychological processes, |
| | feelings and behaviors (such as engagement, decision |
| | making, excitement, achievement, defeat) involved in a |
| | simulated or virtual experience are faithful to the real |
| | experience. |
| Psychometrics | A field or area of study within psychology, concerned |
| | with the objective measurement of human psychological |
| | characteristics such as skills and knowledge, abilities, |
| | attitudes, personality traits, and educational |
| | achievement; the construction and validation of |
| | assessment instruments such as questionnaires, tests, |
| | raters' judgments, and personality tests for the objective |
| | measurement of psychological characteristics. |
| Psychometric Tests | Tests of psychological attributes such as intelligence, |
| | personality and aptitude that have predictive power for |
| | academic or work-related performance. |
| Realistic job previews (RJPs) | A tool used by organizations to communicate the good |
| | and the bad characteristics of the job during the hiring |
| | process of new employees, including sharing |
| | information such as work environment, job tasks, |
| | organizational rules and culture etc. |
| Relative likelihood factor | A multiplicative factor used in the present method, that |
| | is applied to the probability of events in any discrete |
| | probability level to obtain the next higher level. The |
| | higher this value is, the smaller the % age of low |
| | probability events being picked up by the simulation |
| | engine, and so, the less ‘surprising’ the experience will |
| | be |
| Sandbox | Cymorg's experimental virtual environment with |
| | realistic features and data, to simulate a real |
| | organizational set up, where users can navigate issues, |
| | address problems, pursue goals, interact with data and |
| | other users etc. just like they would in reality, but with |
| | an option to retry and experiment with new approaches |
| | each time. |
| Serious games | A game designed for a purpose apart from pure |
| | entertainment; applications include learning, assessment, |
| | realistic previews and simulating reality; widely used in |
| | defense, education, healthcare, emergency management, |
| | organizational leadership development etc. |
| Simulations | Virtual imitation of a real process or system, including |
| | organizational systems; Business simulations involve |
| | presenting users with business/organizational challenges |
| | and context-specific goals, and following how they |
| | navigate the simulated context. |
| Situational judgment tests (SJTs) | A type of psychological test where the respondent is |
| | presented with a realistic scenario and asked to choose |
| | their ideal or typical response to that scenario from a few |
| | alternatives. |
| Skills | A domain-specific ability and capacity to carry out |
| | specific tasks or activities, that may be acquired and |
| | grown through deliberate effort or practice. |
| Standardized scores | Methods to convert scores on different scales or |
| | distributions to make them comparable; placing them on |
| | the same scale (e.g. z-scores or standard scores). |
| State of health | Organizational health for a firm may be measured along |
| | a variety of standpoints - financial, regulatory, |
| | competitive, customer relationships, employee loyalty |
| | etc. For each of these, the condition of the firm at any |
| | juncture can be determined by the values of one or more |
| | data elements. The entire region of possible values for |
| | these data elements can be divided into zones called |
| | “states”. When the firm transitions from one state to |
| | another, because of a user action or the consequence of a |
| | probabilistic event that took place, future events can |
| | become more or less probable. |
| Sten Scores | ‘Standard Ten’ (Sten for short) scores are standardized |
| | scores which allow scores from different scales to be |
| | compared; they are derived using the normal distribution |
| | and z-scores, which divide the distribution into ten parts; |
| | the average Sten is 5.5. and represents the midpoint of |
| | the distribution. |
| Trajectory (of change) | In the present method and system, it is possible to track |
| | change over time and across instances, of individuals as |
| | well as groups. These changes can be plotted as curves |
| | or graphs - trajectories - showing growth or |
| | consistency, for individuals or groups. |
| Trends | As part of the authoring process, historical data is |
| | collected for every parameter or data element that is |
| | tracked as part of a Cymorg simulation. Statistical |
| | regression techniques are applied on this data to |
| | determine a best-fit curve which can then help project |
| | this data into the virtual ‘future’. These projected values, |
| | based on historical data, are the ‘trends’ for the data item. |
| | If no scenario and no user action affects that data item, |
| | the assumption is that the trends would continue from |
| | the past. |
| Threshold state | For every category along which the health of the |
| | organization is measured, one of the zones can be |
| | designated a Threshold State. When the organizational |
| | values transition into the threshold state for any of the |
| | categories, the simulation comes to an end. |
| Unstructured/dynamic | Descriptive of an assessment where the stimuli (e.g. test |
| | items) is not a fixed list but varies based on prior |
| | participant responses and/or other probabilistic |
| | considerations. |
| User | The participant or player of the Cymorg gamified |
| | simulation, the person who navigates the simulation and |
| | receives reports on her/his performance in it. |
| Virtual | A digital replication or close imitation of reality |
| Work sample tests/assessments | Assessments that require one to perform tasks similar to |
| | those that will be used on the job in question |

The description of the invention as given above includes several special terms and example—they are for illustrative purposes only. For example, the terms and use of “gamified simulation”, “state of health”, “expected number of events”, “relative likelihood factor”, “preset average number of events”, “person-situation” model of competency and “paradata” etc. are meant as stand-ins for the concepts described, not for the narrow, specific use herein for Cymorg. The name Cymorg is not meant to limit the use of the terms and concepts in any way.

Having thus described the process, framework and platform of this invention, we claim:

1.-4. (canceled)

5. A computerized method for generating gamified dynamic simulations of the decision making process by a user in an organization, wherein each model of the organization is subject to a set of simulated events such that outcome of any simulated event and consequent state of organizational model depends on the decision made and action taken by the user in the context of the organization as modeled, and wherein the method comprises the following processing steps:
(a) access one or more records of organizational data and user data to validate user;
(b) access one or more records of organizational data to generate an instance of simulation;
(c) initiate a game simulation session for the state of organizational model for the user;
(d) receive input from the user to generate game simulation specific to said user; (e) communicate to the user organizational information in the context of said state of the model;
(f) obtain from the records of data the set of simulated events and their associated probabilities;
(g) present to the user the options for action;
(h) receive from the user a selection of action;
(i) calculate probabilities of simulated set of events for changed state of organizational model as a result of the selection of action by the user;
(j) display changed state of organizational model as a result of the selection of action by the user.

6. The method of claim 5 incorporating the following additional steps:
(k) stop game simulation session if a preset state marker is reached, or if the session is ended by user;
(l) repeat steps (d) to (j);
(m) generate output for the game simulation session.

7. The method of claim 5, wherein said records of organizational data include historical records of actual or virtual simulated events, along with the probabilities and outcomes attached to states of the organizational model relevant to said instance of simulation and event options.

8. The method of claim 6, wherein output comprises updated data of events selected and corresponding consequences and probabilities, additional updated organizational data including the state of the system.

9. The method of claim 5, further comprising the following steps to generate a quantitative measure of one or more user competencies over a set of predefined attributes:
(ma) receive an algorithm to select events from said simulated events;
(mb) present to the user one or more of selected events based on user input in step (d);
(mc) receive user responses to the one or more of selected events;
(md) access a prespecified scoring scheme to evaluate user responses to said one or more selected events;
(me) analyze user responses to selected events to evaluate by the scoring scheme user competency for one or more of predefined attributes;
(mf) find user competency score for one or more of predefined attributes based on the evaluation.

10. The method of claim 9 incorporating the following additional steps:
(mg) provide a subset of said set of predefined attributes;
(mh) provide for each of said subset of the set of predefined attributes an adequate measure of competency;
(mi) stop evaluation for attribute in said subset if adequate measure of competency is reached;
(mj) repeat steps (mc) to (me);
(mk) stop game simulation session if evaluation for all attributes in said subset stopped, or if the session is ended by user;
(ml) generate output for the game simulation session.

11. The method of claim 9 comprising the following additional steps:
(m1) receive formula to convert the user competency score to a standardized score;
(m2) generate standardized competency score for the user for said attribute in said subset.

12. The method of claim 11 wherein said output comprises updated data of events selected and corresponding consequences and probabilities, state of the system including notifications, and aggregates of the standardized scores for the user for all the action responses.

13. The method of claim 11 incorporating the following additional steps:
(n1) receive standardized competency score for said attribute for one or more of a set of users for a comparison;
(n2) compare standardized competency score for the user against standardized competency score for one or more of said set of users.

14. The method of claim 13, wherein said attribute is each of the attributes in the set of predefined attributes.

15. The method of claim 9 wherein evaluation in the form of text is associated with a user competency score or with a standardized score.

16. The method of claim 9 wherein said algorithm for selecting events is compatible with Hidden State Markovian model of the organization such that the probability of an event taking place increases or decreases according to the circumstances defined by the state of the organization along one or more of the dimensions relevant to the model at the time of event selection.

17. A computerized system for generating dynamic simulations of the decision-making process by a user in an organization, wherein each model of the organization is subject to a set of simulated events such that outcome of any simulated event and consequent state of organizational model depends on the decision made and action taken by the user in the context of the organization as modeled, and wherein the system comprises the following processing components:
(a) a component or components to access one or more of the records of data to generate an instance of simulation;
(b) a component or components for communication with the user;
(c) a component or components to receive input from the user;
(d) a component or components to communicate to the user organizational information in the context of said model;
(e) a component or components to receive list of simulated events with the computed or associated probabilities;
(f) a component or components to provide to the user options for decision and action in response to one or more of said events;
(g) a component or components to receive from the user a selection of an action;
(h) a component or components to calculate or recalculate probabilities of simulated events as a result of the action selected by the user;
(i) a component or components to display to the user computed or recomputed state of organizational model.
